(19) United States
(12) Patent Application Publication
(10) Pub. No.: US 2024/0338596 A1
(43) Pub. Date: Oct. 10, 2024

(54) SIGNALLING MODEL PERFORMANCE FEEDBACK INFORMATION (MPFI)

(71) Applicant: Telefonaktiebolaget LM Ericsson (publ), Stockholm (SE)

(72) Inventors: Ioanna PAPPA, STOCKHOLM (SE); Luca LUNARDI, GENOVA (IT); Johan RUNE, LIDINGÖ (SE); Pablo SOLDATI, SOLNA (SE); Henrik RYDÉN, STOCKHOLM (SE); Philipp BRUHN, AACHEN (DE); Angelo CENTONZA, GRANADA (ES)

(73) Assignee: Telefonaktiebolaget LM Ericsson (publ), Stockholm (SE)

(21) Appl. No.: 18/294,985

(22) PCT Filed: Aug. 2, 2022
(86) PCT No.: PCT/EP2022/071631

§ 371 Date: Feb. 2, 2024

Related U.S. Application Data
(60) Provisional application No. 63/229,886, filed on Aug. 5, 2021.

(51) Int. Cl. G06N 20/00

(52) U.S. Cl. CPC G06N 20/00

(57) ABSTRACT

A method (400) performed by a first network node (101). The method includes the first network node obtaining (s402) model performance feedback information (MPFI) for an artificial intelligence (AI) model. The method also includes the first network node providing (s404) the MPFI to a model training function (112). The MPFI provides information that the model training function (112) can use to determine whether the AI model needs to be updated or replaced by a new AI model.

### TECHNICAL FIELD

This disclosure relates to providing model performance feedback information (MPFI) to a network node.

### BACKGROUND

### 1. RAN 3

A Study Item (SI) named “Enhancement for Data Collection for NR and EN-DC” is defined in 3GPP RP-201620. The study item aims to study the functional framework for Radio Access Network (RAN) intelligence enabled by further enhancement of data collection through use cases, examples etc. and identify the potential standardization impacts on current Next Generation RAN (NG-RAN) nodes and interfaces.

The detailed objectives of the SI are listed as follows: a) Study high level principles for RAN intelligence enabled by Artificial Intelligence (AI), the functional framework (e.g. the AI functionality and the input/output of the component for AI enabled optimization) and identify the benefits of AI enabled NG-RAN through possible use cases e.g. energy saving, load balancing, mobility management, coverage optimization, etc.; b) Study standardization impacts for the identified use cases including: the data that may be needed by an AI function as input and data that may be produced by an AI function as output, which is interpretable for multi-vendor support; c) Study standardization impacts on the node or function in current NG-RAN architecture to receive/provide the input/output data; and d) Study standardization impacts on the network interface(s) to convey the input/output data among network nodes or AI functions. As part of the SI work, a Text Proposal (TP) has been agreed for 3GPP Technical Report (TR) 37.817 in R3-212978.

### 2. Uncertainties in Predictions

Uncertainty is a key notion in AI (e.g., Machine Learning (ML)) and uncertainty quantification is a key element for trustworthy and explainable AI. Accuracy quantifies how close a prediction is to the true value and can only be measured once the true value is known. It is often determined as average for many predictions and used to evaluate and compare the predictive power of AI algorithms. Uncertainty, on the other hand, assesses how much a prediction may differ from the true value and can be estimated along with the prediction.

There are two inherently different sources of uncertainty, often referred to as aleatoric uncertainty and epistemic uncertainty. Aleatoric (or statistical) uncertainty refers to the noise in the data, meaning the probabilistic variability of the output due to inherent random effects. It is irreducible, which means that it cannot be reduced by providing more data or choosing a different AI model (also known as, “AI algorithm”). By contrast, epistemic (or systematic) uncertainty comes from limited data and knowledge about the system and underlying processes and phenomena. Regarding AI, it refers to the lack of knowledge about the perfect model, e.g. best model parameters, typically due to inappropriate or insufficient training data. This part of the total uncertainty is in principle reducible, for example by providing more data.

Epistemic uncertainty describes what the model does not know because training data was not appropriate. Epistemic uncertainty is due to limited data and knowledge. Given enough training samples, epistemic uncertainty will decrease. Epistemic uncertainty can arise in areas where there are fewer samples for training.

Aleatoric uncertainty is the uncertainty arising from the natural stochasticity of observations. Aleatoric uncertainty cannot be reduced even when more data is provided. Aleatoric uncertainty can further be categorized into homoscedastic uncertainty, uncertainty which stays constant for different inputs, and heteroscedastic uncertainty. Heteroscedastic uncertainty depends on the inputs to the model, with some inputs potentially having more noisy outputs than others.

### 3. Uncertainties in ML Models

When training an ML model, the selected process will affect the level of uncertainty that can be estimated. In general, a more complex process (e.g. Gaussian process) can estimate the uncertainty more accurately than a simpler process. For example, FIG. 1 illustrates the 95% prediction intervals for two models obtained by different processes. The first model is derived from a Gaussian process, which can learn the heteroscedastic noise process comprised in the training data. Thus, the size of the prediction interval for this model depends on the input to the model. FIG. 1 shows that the Gaussian process estimates a higher (epistemic) uncertainty for 2≤x≤4, due to the lack of training samples, and a higher (aleatoric) uncertainty for 6≤x≤8, due to the higher noise level. By contrast, the second model is obtained by linear regression with polynomial features, which is a much simpler process. In this case, the size of the prediction interval is constant for all inputs, so it does not depend on the input. Therefore, the uncertainty estimation is much less accurate, since it cannot capture the heteroscedastic noise process in a meaningful way.

### SUMMARY

Certain problems presently exist. For example, during the operation of an AI model (e.g., a ML model), it may happen that i) the accuracy of the output predictions drops and/or ii) individual point predictions, even though are on average accurate, may suffer from different levels of uncertainty. For instance, an AI model may on average perform well by, for example, providing a good level of accuracy over multiple model inference output samples, but an individual model inference output may experience a relatively high uncertainty (regardless whether the prediction was correct or not). One of the reasons why the uncertainty of the output may change with time is that the model producing the outputs has received inputs that drifted with time to new input value ranges.

Accordingly, when the output of the AI model is provided as input to a second network function (e.g. to a second AI model or to a further process that uses such output to determine specific actions), the second node hosting the second function could unknowingly use information with high uncertainty, which could compromise its performance.

Inaccurate uncertainty measures can be due to changes that occur between training the model and deploying the trained model. For example, the level of inference measurement accuracy might not match the training data and can cause erroneous use of a trained ML model because the model was trained on a specific set of inputs, but when the model was used to infer outputs, the model was given inputs not used during the training process.

In one example (shown in FIG. 2 below), the measurement accuracy in training data comprises a Gaussian noise with STD=1, however, in the inference phase one node might experience higher measurement noise. Since the uncertainty in each sample is derived by the training function from the training process the MSE from training is 1.08, while the actual inference MSE equals 4.08. Note that in case the inference node is not able to retrieve the response variable y (e.g. because the model was not trained for the corresponding input), there is no method for such node to accurately estimate the uncertainty of its predictions. The model may therefore continue to report a per-sample MSE of 1.08, while it is much higher. In general, scenarios might change from training to inference due to: 1) changes in the environment, such as, for example, changes in the network deployments, changes in the radio coverage, changes in the ranges of values that can be measured by devices in a network, new chains of inferring models; 2) seasonal variations, for example, training data gathered during a certain time period might not be valid for another time period; and/or 3) node capabilities, for example data collected from an advanced receiver/transmitter might not be valid for a less advanced receiver.

Accordingly, in one aspect there is provided a method performed by a first network node. The method includes the first network node obtaining model performance feedback information, MPFI, for an artificial intelligence, AI, model. The method also includes the first network node providing the MPFI to a model training function. The MPFI provides information that the model training function can use to determine whether the AI model needs to be updated or replaced by a new AI model. In some embodiments, the method also includes determining whether a condition is satisfied, wherein the first network node provides the MPFI to the model training function in response to determining that the condition is satisfied, and determining whether the condition is satisfied comprises: the first network node determining an uncertainty value indicating an uncertainty with respect to an input to the AI model or indicating an uncertainty with respect to an output of the AI model; and comparing the uncertainty value to a threshold. In some embodiments, the first network node periodically obtains MPFI and periodically provides the MPFI to the model training function. In some embodiments, providing the MPFI to a model training function comprises the first network node transmitting the MPFI to a third network node that is configured to forward the MPFI to the model training function.

In another aspect there is provided a method performed by a second network node. The method includes the second network node receiving first model performance feedback information, MPFI, for a first existing artificial intelligence, AI, model used by a first network node. The method also includes the second network node using the first MPFI to determine whether a new AI model (e.g., new AI model parameters) needs to be provided to the first network node so that the first network node can update or replace the first existing AI model with the new AI model. In some embodiments, the method also includes, in response to determining that a new AI model needs to be provided to the first network node, generating the new AI model; and providing the new AI model to a first network node. In some embodiments, the method also includes, the second network node receiving second MPFI for a second existing AI model used by a fourth network node; and the second network node using the first MPFI and the second MPFI to determine whether a new AI model needs to be provided to at least one of the first network node and the fourth network node.

In some embodiments, the MPFI comprises at least one of: a) information related to uncertainty associated to one or more model inference data samples, b) information related to uncertainty associated to one or more AI model inference output, c) information that can indicate the uncertainty of the predictions made by the AI model, or d) information associated to the predictions made by the AI model.

In another aspect there is a method that includes a network node obtaining inference input data. The method also includes the network node obtaining uncertainty information indicating an uncertainty measure associated with the inference input data. The method also include the network node providing to a model inference function the inference input data and the uncertainty information associated with the inference input data.

In another aspect there is provided a computer program comprising instructions which when executed by processing circuitry of a network node causes the network node to perform any of the methods disclosed herein. In another aspect there is provided carrier containing the computer program, wherein the carrier is one of an electronic signal, an optical signal, a radio signal, and a computer readable storage medium.

In another aspect there is provided a network node that is configured to obtain model performance feedback information, MPFI, for an artificial intelligence, AI, model. The network node is further configured to provide the MPFI to a model training function, wherein the MPFI provides information that the model training function can use to determine whether the AI model needs to be updated or replaced by a new AI model.

In another aspect there is provided a network node that is configured to receive first model performance feedback information, MPFI, for a first existing artificial intelligence, AI, model used by a first network node. The network node is further configured to use the first MPFI to determine whether a new AI model needs to be provided to the first network node so that the first network node can update or replace the first existing AI model with the new AI model.

In another aspect there is provided a network node that is configured to obtain inference input data and obtain uncertainty information indicating an uncertainty measure associated with the inference input data. The network node is further configured to provide to a model inference function the inference input data and the uncertainty information associated with the inference input data.

In another aspect there is provided a network node that comprises a data storage system and processing circuitry, wherein the network node is configured to perform any one of the methods disclosed herein.

The embodiments disclosed herein provide the advantage of enabling a network node hosting an AI model training function to receive feedback information comprising one or more performance metrics associate to the AI model to be trained. The reported information may comprise uncertainty measures of the output produced by the AI model, thereby indicating whether the algorithm performs well or needs to be re-trained. Additionally or alternatively, the performance metric may indicate uncertainty information associated to the input data on which the AI model currently operates, which could indicate whether such information has been captured in previous training instanced or not.

### BRIEF DESCRIPTION OF THE DRAWINGS

The accompanying drawings, which are incorporated herein and form part of the specification, illustrate various embodiments.

FIG. 1 illustrates model uncertainties.

FIG. 2 illustrates an example where performance can differ between model training and model inference.

FIG. 3 illustrates a system according to some embodiments.

FIG. 4 is a flow chart illustrating a process according to some embodiments.

FIG. 5 is a flow chart illustrating a process according to some embodiments.

FIG. 6 is a flow chart illustrating a process according to some embodiments.

FIG. 7 is a block diagram illustrating a network node according to some embodiments.

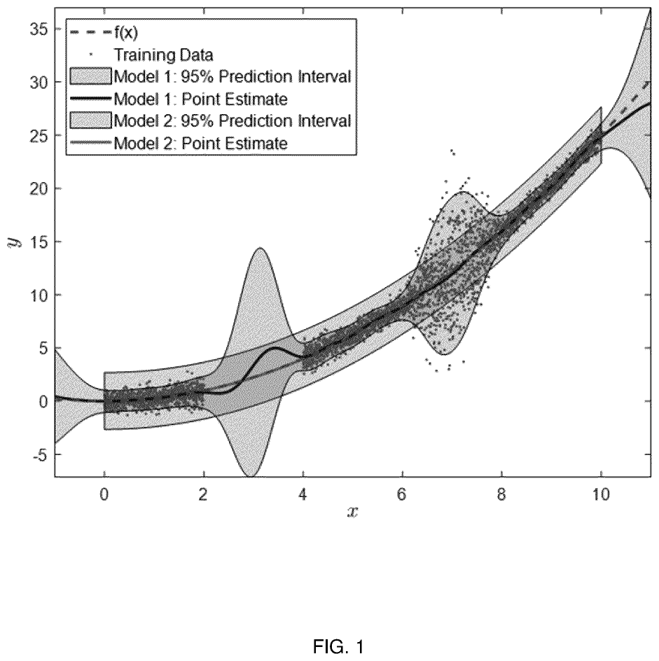

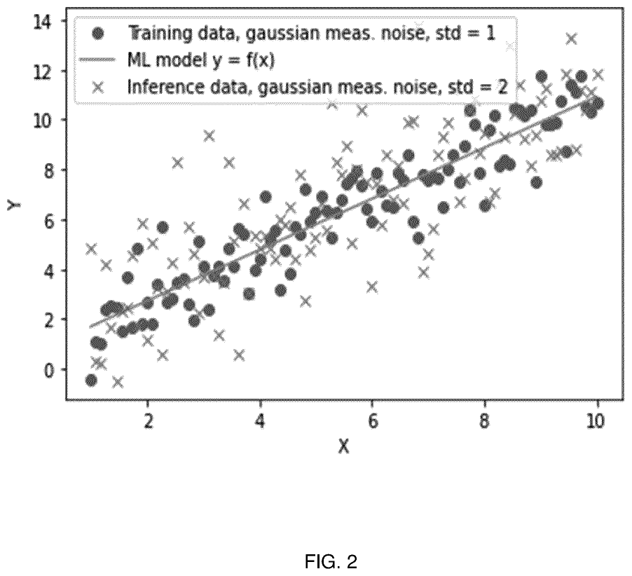

### DETAILED DESCRIPTION

One way to handle the above-described problem, and correspondingly limit the effect of utilizing inputs with high uncertainty, is to signal to a model training function information related to inference output uncertainty or information related to the input values with which the inference model is operating. In this way, the model training function will be able to have a view of the uncertainty of the outputs produced by the model inference function and correspondingly take action to remedy the issue. Such actions may consist of re-training the model to produce a new model that is subject to better uncertainty for the outputs generated from the inputs in use by the current model inference function. Once such new trained model is available, the new model may be provided to the host of the inference function that is subject to high uncertainty outputs. Such providing may be carried out by the node hosting the model training function or by any other system that can have access to the newly trained model and that can deploy such model to the node hosting the model inference function subject to high uncertainty.

In some embodiments, a model inference function may be hosted by many different network nodes and not all model inference hosts may experience problems with the model inference output uncertainty. Therefore, there might exist in the network model inference hosts that need not obtain a re-trained model inference function because the current model inference function produces outputs with acceptable uncertainty.

The methods described herein cover the possibility of identifying problems with model inference outputs uncertainty with the granularity of model inference hosts, i.e. with the granularity of each instance of the model inference function deployed to a model inference host.

The methods described herein also cover the possibility of improving the output uncertainty on a per model inference host basis, e.g. by means of retraining the model and deploying the re-trained model only to the model inference hosts for which uncertainty issues have been detected

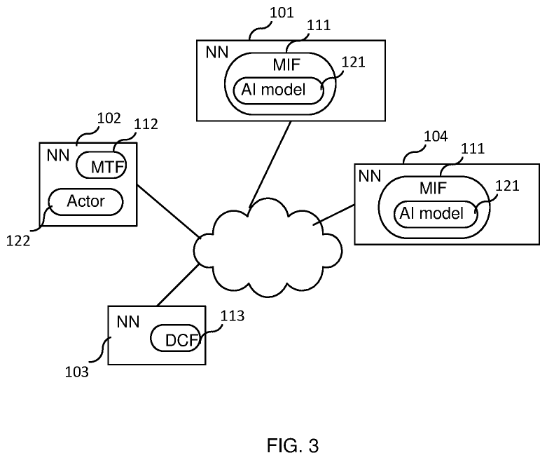

FIG. 3 illustrates a system 300 according to an embodiment. System 300 includes a first network node (NN) 101, a second network node 102, a third network node 103, and a network 110 that enables the network nodes to communicate with each other. First network node 101 may be a RAN node, such as any one of the following: a 5G base station (gNB), a 4G base station (eNB), a gNB distributed unit (gNB-DU), a gNB-CU control plane (gNB-CU-CP), a gNB-CU user plane (gNB-CU-UP), an eNB-DU, an eNB-CU-CP, or an eNB-CU-UP. Second network node 102 may be a component of an Operations and Maintenance (O&M) system.

In one embodiment, first network node 101 hosts a model inference function (MIF) 111 of a trained AI model 121, and second network node 102 hosts a model training function (MTF) 112 and/or one or more AI actors 122, and third network node 103 hosts a data collection function (DCF) 113.

In one embodiment, data collection function 113 is a function that provides training input data to model training function 112 and/or provides inference input data to model inference function 111. Examples of such training/inference input data may include measurements from communication devices (e.g., mobile phones or any other communication device) or different network entities, performance feedback, etc. Training input data is information needed for the AI model training function, and inference input data is information needed as an input for the model inference function 111 to provide a corresponding output.

Model training function 112 is a function that performs the training of the AI model. The model training function is also responsible for data preparation (e.g. data pre-processing and cleaning, formatting, and transformation of raw data), if required.

Model inference function 111 is a function that employs the AI model 121 to provide AI model inference output (e.g., predictions or decisions). The model inference function is also responsible for data preparation (e.g. data pre-processing and cleaning, formatting, and transformation of raw data), if required. In some embodiments, when model inference function 111 provides an output that includes or consists of a prediction, model inference function 111 also may provide an uncertainty value indicating the accuracy level of the prediction (e.g., the accuracy level for which the AI model 121 is trained) and/or validity time information indicating a time period for which the prediction is valid (e.g., a “best before” time for the prediction result).

Actor 122 is a function that obtains (e.g., receives) the AI model output produced by model inference function 111 and triggers or performs corresponding actions. The Actor may trigger actions directed to other entities or to itself. In one embodiment, model training function 112 trained AI model 121 and then provided the trained AI model to first network node 101.

In one embodiment, first network node 101 is configured to obtain information associated with input(s) and/or output(s) of the AI model 121. The obtained information includes at least one of: 1) information indicating the presence or absence of one or more types of uncertainty in model inference output and/or input; 2) information indicating level(s) of uncertainty in model inference output; 3) information indicating level(s) of uncertainty in model inference input (inference data), for example the uncertainty for each of the model inputs, or an aggregated value for all, or a subset of inputs; the subset can be selected based on the type of input, for example a subset can comprise all signal quality measurements; or 4) information indicating one or more inference output (e.g., predictions) to which the uncertainties refer. The first network node uses this information to obtain model performance feedback information (MPF) I which is then may be signaled to the second network node, as described below.

In one embodiment, the type of uncertainty in model inference output or in the model inference input may indicate one or more kinds of uncertainty in the group of: aleatoric, epistemic, heteroscedastic, homoscedastic, aleatoric heteroscedastic, aleatoric homoscedastic, epistemic heteroscedastic, epistemic homoscedastic.

In one embodiment, first network node 101 obtains MPFI (e.g., uncertainty statistics regarding the inputs and/or outputs for the AI model 121) and provides the MPFI to second network node 102. This MPFI is referred to as “inference” MPFI. In one example, MPFI is signaled via a “Model deployment” message and/or a “Model Update” message or the like. In one embodiment, the MPFI includes at least one of: 1) information indicating epistemic uncertainty of the inputs to the AI model; 2) information indicating uncertainty of the model inference output; 3) other information that can indicate the uncertainty of the predictions; or 4) other information associated to the predictions.

Second network node 102 then can compare the inference MPFI received from first network node 101 with corresponding “training” performance information (e.g., uncertainty statistics)—i.e., input and/or output performance information that second network node 102 obtained with respect to training the AI model 121. For example, second network node 102 can check whether an uncertainty statistic for a certain feature is same with respect to inference and training.

In another embodiment, the first node determines and/or receives configuration information for reporting MPFI associated with AI model 121 to second network node 102. First network node 101 may receive the configuration information from second node and/or from third network node 103.

In one embodiment, second network node 102 transmits to first network node 101 a MPFI subscription request that comprises the configuration information for reporting the MPFI. Such request from second network node 102 may be interpreted by first network node 101 as a subscription to receive such information. The request may specify one or more criteria according to which the information on uncertainty should be provided, for example: a) uncertainty information should be provided for every input received and/or for any output produced; b) input uncertainty information should be provided only if the level of uncertainty increases above and/or decreases below a given threshold; c) output uncertainty information should be provided only if the level of uncertainty increases above and/or decreases below a given threshold; d) input uncertainty information should be provided only if inputs are within one or more specified ranges; and/or e) output uncertainty information should be provided only if inputs are within one or more specified ranges.

In one embodiment, first network node 101, in response to receiving the subscription request from second network node 102, transmit to second network node 102 a subscription response indicating: 1) a successful initialization (ACK) of the feedback subscription; 2) a partially successful initialization of the feedback subscription; or 3) an unsuccessful initialization (NACK) of the feedback subscription.

In some embodiments, the configuration information for reporting the MPFI includes at least one of: 1) a threshold to mark a distinction between inference output with acceptable/not acceptable aleatoric uncertainty, 2) a threshold to distinguish inference data with acceptable/not acceptable aleatoric uncertainty, 3) a threshold in epistemic uncertainty for inference output, 4) an indication to ignore/discard inference data affected by epistemic uncertainty, or 5) an indication to not send inference output affected by epistemic uncertainty. In one embodiment, first network node 101 determines that one or more performance of the model is not satisfactory according to the indications specified above.

In one example, second network node 102 is a node where one or more AI actors are deployed, and the second network node 102 sends a subscription request to the first network node to receive performance(s) of model inference from the first node (e.g., to receive MPFI).

In some embodiments, second network node 102, after receiving the MPFI provided by first network node 101, may determine, based on the MPFI, to produce a new AI model (e.g., retrain or update the AI model). After second network node 102 generates the new AI model, second network node 102 may provide the new AI model to first network node 101, which then will update or replace the existing model 121 with the new model. For example, second network node 102 may send to first network node 101 a model deployment update message comprising the new AI model. In one embodiment, when second network node 102 determines that the AI model requires to be updated or retrained, second network node 102 trains the AI model to improve its performance and transmits the new AI model to first network node 101.

### Additional Embodiments

In some embodiments, first network node 101 determines changes in the output uncertainty of the trained AI model 121 by performing a sensitivity analysis. To this end, first network node 101 obtains N input data sets wherein each one of the input data sets is slightly different than each of the other N−1 input data sets, and, for each input data set, first network node 101 executes the AI model on the input data set to produce an output (e.g., the initial calculation is performed on real data and the N−1 other calculations are performed on a variation of the real data). In this way, first network node 101 produces N outputs, where each of the N outputs correspond to a different one of the N input data sets. First network node 101 can then determine the variation in the outputs.

If the variation of the outputs, e.g. the variance of a scalar output value, is too large (e.g. larger than a predetermined threshold), first network node 101 determines that the uncertainty in the output has changed and has become undesirably large. As one example, if the output is a single scalar value, the uncertainty could be expressed in terms of the probability of a certain error, e.g. the 95th percentile (or any other percentile) error size.

In response to determining that the uncertainty exceeds the predetermined threshold, first network node 101 triggers the model training function 112 to generate a newly trained AI model to update or replace trained AI model 121. For example, in one embodiment, first network node 101 triggers the model training function 112 by providing to the model training function 112 MPFI that indicates that retraining (or additional training) of AI model 121 using more (and preferably new) data samples is needed. In another embodiment, instead of directly triggering the model training function 112 to generate a new AI model, first network node 101 informs third network node 103 (e.g., first network node 101 sends the MPFI to third network node 103) and third network node 103 can then trigger the model training function 112 to perform retraining (or additional training) based on relevant training data by, for example, forwarding at least a part of the received MPFI to the model training function 112.

As one option, the MPFI that first network node 101 sends to the model training function 112 (or to third network node 103) may include information about which input data triggered the detection of increased uncertainty in the output data. This may be useful for the model training function 112 to know, so that it, as one option, can focus the retraining (or additional training) on training data that resembles the input data indicated by the MPFI provided by first network node 101.

A potential problem with the sensitivity analysis method may be that it does not satisfy possible real-time requirements, since it takes a non-negligible time to run the calculation (i.e., execute the model) multiple times. One way to overcome this potential issue is to configure first network node 101 such that it does not perform this sensitivity analysis for every new model inference data sample where an output is to be calculated. Instead, it could initiate the sensitivity analysis only for every Nth (e.g. every 10th) output calculation and then run the sensitivity analysis in the background. In one alternative, it could initiate the sensitivity analysis only when calculating the output for a new or unseen inputs that have at least a certain distance to any previous or seen inputs for which such analysis has already been done. The distance between two input samples in the N-dimensional input space may be measured in any way, e.g., as Euclidian distance.

### Method Executed at First Network Node 101:

In one embodiment, first network node 101 transmits to second network node 102 MPFI related to AI model 121, wherein the MPFI includes at least one of: a) information related to uncertainty associated to one or more model inference data samples (i.e., input data to the AI model); b) information related to uncertainty associated to one or more AI model inference output; c) information that can indicate the uncertainty of the predictions made by the AI model; or d) information associated to the predictions made by the AI model.

First network node 101 may transmit the MPFI to second network node 102 periodically or based on a trigger (e.g., the MPFI is sent only when the uncertainty of the inference output passes a threshold).

In some embodiments, first network node 101 receives (directly or indirectly) from third network node 103 inference data sample information that includes one or more model inference data samples and an indication of an uncertainty measure associated to the one or more model inference data samples. The MPFI provided by first network node 101 to second network node 102 may consist of or comprise the uncertainty measures first network node 101 receives from third network node 103.

Third network node 103 may transmit the inference data sample information to first network node 101 periodically or in response to a trigger. For example, a request received by second network node 102 may cause second network node 102 to ask first network node 101 to report information about uncertainty, which then causes first network node 101 to request the uncertainty information from third network node 103.

The second network node 102 may send a subscription request to the first network node to obtain MPFI (e.g., uncertainty information) to distinguish cases where second network node 102 is able to process information related to uncertainty from first network node 101 and derive appropriate actions aimed at improving the uncertainty at first network node 101. If second network node 102 is not able to process such information and take appropriate output, then second network node 102 may decide not to request uncertainty information from first network node 101. In this case, if second network node 102 still receives information on uncertainty, second network node 102 may discard such information.

### Method Executed by Second Network Node 102

In one embodiment, second network node 102 receives MPFI related to trained AI model 121 (e.g., the MPFI may be received directly or indirectly from first network node 101, as described above). The MPFI may include: a) information related to uncertainty associated to one or more model inference data samples (i.e., input data to the model) and/or b) information related to uncertainty associated to one or more model inference output. After receiving the MPFI, second network node 102 determines, based on the MPFI whether the associated AI model (i.e., AI model 121) needs to be updated (e.g., trained using new input data). If second network node determines that the AI model needs to be updated, then second network node 102 trains the AI model to improve its performance and transmits the newly trained AI model to first network node 101. In this way, first network node 101 receives an updated AI model to update or replace the previously trained AI model 121.

In one embodiment, system 300 includes additional network nodes that run AI model 121 (these additional one or more network nodes are represented by network node 104) and second network node 102 may receive MPFI related to AI model 121 from (directly or indirectly) each of the network nodes that run AI model 121. In such a case, second network node 102 may evaluate from all of the MPFI received whether the overall level of uncertainty across the multitude of nodes that run AI model 121 is acceptable or whether an action to improve such uncertainty is needed. That is, for example, second network node: i) receives first MPFI from network node 101, ii) receives second MPFI from network node 104, and iii) uses both the first MPFI and the second MPFI to determine whether or not to produce a new AI model (e.g., an updated model) to update or replace AI model 121.

Additionally, if an action is needed to improve uncertainty, second network node 102 may further decide whether such action needs to involve all the network nodes in the multitude of nodes providing the MPFI or whether the action needs to be directed only towards some of these nodes, e.g. those nodes that reported uncertainty measures above a certain threshold or those nodes that were in a given percentile of nodes with the worst uncertainty measures. Accordingly, In one example, the action the second node 102 may take in response to determining that an action is needed to improve uncertainty (i.e., whether or not to produce a new AI model) is to retrain the AI model in a way to improve the uncertainty affecting its outputs and provide (e.g., signal) such re-trained version of the AI model (i.e. the new AI model) only to those nodes for which it was determined that an action to improve uncertainty is needed.

### EXAMPLES

### 1. Network Forecasted Load for Traffic Steering

In one embodiment, first network node 101 is RAN node and AI model 121 is an ML model that uses an input data set to predict the future load (e.g., load in the next 10-minute interval) of the RAN node. That is, the output of AI model 121 is a value indicating the predicted load. First network node 101 may determine that the uncertainty associated with the input data set has increased (e.g. has increased above a threshold). As a result of making this determination, first network node 101 signals to the model training function 112 MPFI that indicates that the uncertainty of the inputs has increased. The model training function 112 then adjusts AI model 121 by retraining it using new data in order to reduce the epistemic uncertainty of the input data. The new model that is produced by this retraining is then provided to first network node 101, which then replaces its existing AI model with the new AI model (e.g., first network node 101 may replace the existing AI model by updating the AI model).

### 2. RAN Energy Saving

In another embodiment, first network node 101 is a RAN node (e.g., a base station) that is configured to obtain energy savings by offloading some users to a another RAN node and then, for example, deactivate one of its served cells or SSB beams. In this scenario, AI model 121 is configured to use a set of input data to predict if energy savings actions are possible in a future time interval. The set of input data may comprise load related information comprising resource status in the past as well as predicted resource status in the future time interval. Information pertaining predicted resource status comprises predicted load metrics for cells and SSB areas served by first network node 101 and predicted load metrics for cells and SSB areas served by a second network node neighboring first network node 101. In one embodiment, when the epistemic uncertainty of the input data rises above a certain threshold level, first network node 101 signals to the model training function 112 MPFI that indicates the input uncertainty; in another embodiment, the MPFI that indicates the input uncertainty is transmitted to the model training function 112 periodically (e.g., occasionally) regardless of whether or not the epistemic uncertainty of the input data exceeds the threshold. Consequently, the model training function 112 can use the MPFI to decide whether or not to retrain the AI model with more data. That is, depending on the received MPFI, model training function 112 either decides that the AI model 121 is providing trustworthy predictions or decides that a new AI model need to be generated (e.g., the AI model 121 needs additional training).

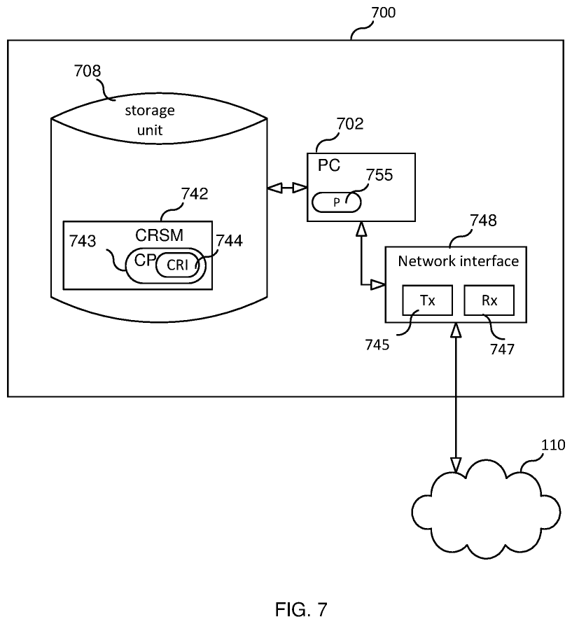

FIG. 7 is a block diagram of a network node 700, according to some embodiments, that can implement any of the network nodes disclosed herein (e.g., network node 101 or network node 102). As shown in FIG. 7, network node 700 may comprise: processing circuitry (PC) 702, which may include one or more processors (P) 755 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., network node 700 may be a distributed computing apparatus); at least one network interface 748 (e.g., a physical interface or air interface) comprising a transmitter (Tx) 745 and a receiver (Rx) 747 for enabling network node 700 to transmit data to and receive data from other nodes connected to a network 110 (e.g., an Internet Protocol (IP) network) to which network interface 748 is connected (physically or wirelessly) (e.g., network interface 748 may be coupled to an antenna arrangement comprising one or more antennas for enabling network node 700 to wirelessly transmit/receive data); and a storage unit (a.k.a., “data storage system”) 708, which may include one or more non-volatile storage devices and/or one or more volatile storage devices. In embodiments where PC 702 includes a programmable processor, a computer readable storage medium (CRSM) 742 may be provided. CRSM 742 may store a computer program (CP) 743 comprising computer readable instructions (CRI) 744. CRSM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes network node 700 to perform steps described herein (e.g., steps described herein with reference to the flow charts). In other embodiments, network node 700 may be configured to perform steps described herein without the need for code. That is, for example, PC 702 may consist merely of one or more ASICs. Hence, the features of the embodiments described herein may be implemented in hardware and/or software.

### SUMMARY OF VARIOUS EMBODIMENTS

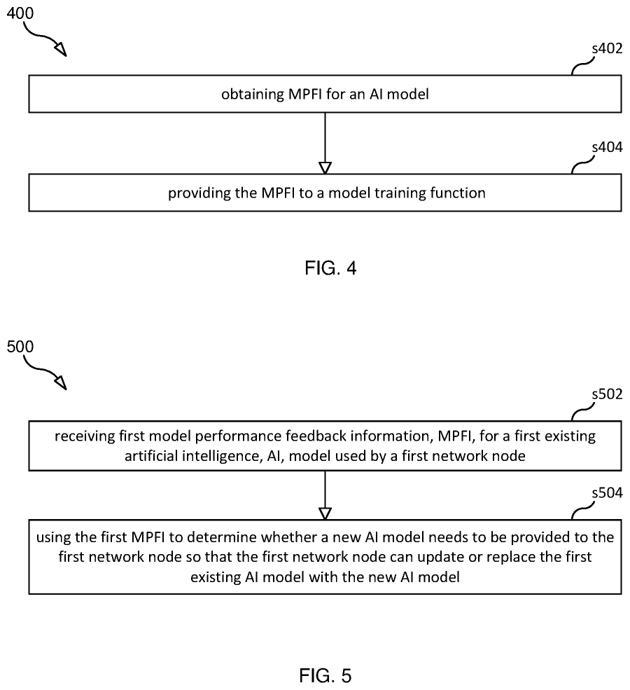

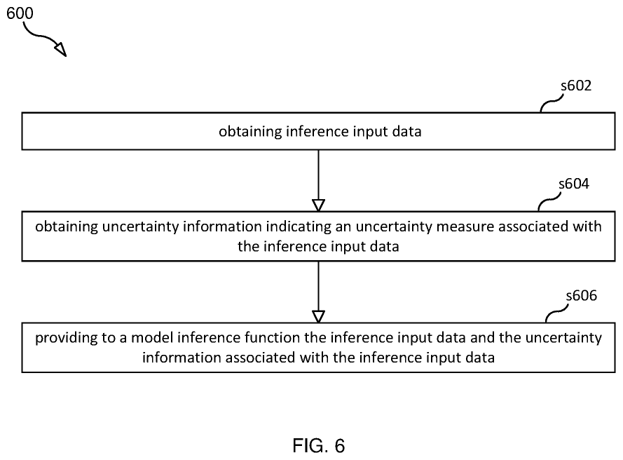

A1. A method 400 (see FIG. 4) performed by a first network node 101, the method comprising: the first network node obtaining model performance feedback information (MPFI) for an artificial intelligence (AI) model (see step s402 in FIG. 4) and the first network node providing the MPFI to a model training function 112 (see step s404 in FIG. 4). The MPFI provides information that the model training function 112 can use to determine whether the AI model needs to be updated or replaced by a new AI model.
A2. The method of embodiment AI, wherein the MPFI comprises at least one of: a) information related to uncertainty associated to one or more model inference data samples, b) information related to uncertainty associated to one or more AI model inference output, c) information that can indicate the uncertainty of the predictions made by the AI model, or d) information associated to the predictions made by the AI model.
A3. The method of embodiment AI or A2, further comprising determining whether a condition is satisfied, wherein the first network node provides the MPFI to the model training function in response to determining that the condition is satisfied, and determining whether the condition is satisfied comprises: the first network node determining an uncertainty value indicating an uncertainty with respect to an input to the AI model or indicating an uncertainty with respect to an output of the AI model; and comparing the uncertainty value to a threshold.
A4. The method of embodiment AI or A2, wherein the first network node periodically obtains MPFI and periodically provides the MPFI to the model training function.
A5. The method of any one of embodiments AI-A4, wherein providing the MPFI to a model training function 112 comprises the first network node transmitting the MPFI to a third network node 103 that is configured to forward the MPFI to the model training function.
B1. A method 500 (see FIG. 5) performed by a second network node 102, the method comprising: the second network node receiving first model performance feedback information (MPFI) for a first existing artificial intelligence (AI) model used by a first network node 101 (see step s502 in FIG. 5); and the second network node using the first MPFI to determine whether a new AI model (e.g., new AI model parameters) needs to be provided to the first network node so that the first network node can update or replace the first existing AI model with the new AI model (see step s504 in FIG. 5).
B2. The method of embodiment B1, wherein the MPFI comprises at least one of: a) information related to uncertainty associated to one or more model inference data samples, b) information related to uncertainty associated to one or more AI model inference output, c) information that can indicate the uncertainty of the predictions made by the AI model, or d) information associated to the predictions made by the AI model.
B3. The method of embodiment B1 or B2, further comprising: in response to determining that a new AI model needs to be provided to the first network node, obtaining (e.g., generating) the new AI model; and providing the new AI model to a first network node.
B4. The method of any one of embodiments B1-B3, further comprising: the second network node receiving second MPFI for a second existing AI model used by a fourth network node 104; and the second network node using the first MPFI and the second MPFI to determine whether a new AI model needs to be provided to at least one of the first network node and the fourth network node.
C1. A method 600 (see FIG. 6) comprising: a network node obtaining inference input data (see step s602 in FIG. 6); the network node obtaining uncertainty information indicating an uncertainty measure associated with the inference input data (see step s604 in FIG. 6); and the network node providing to a model inference function 111 the inference input data and the uncertainty information associated with the inference input data (see step s606 in FIG. 6).
D1. A computer program 743 comprising instructions 744 which when executed by processing circuitry 702 of a network node 101, 102, 103 causes the network node to perform the method of any one of the above embodiments.
D2. A carrier containing the computer program of embodiment C1, wherein the carrier is one of an electronic signal, an optical signal, a radio signal, and a computer readable storage medium 742.
E1. A network node 101, the network node being configured to: obtain model performance feedback information, MPFI, for an artificial intelligence, AI, model; and provide the MPFI to a model training function 112, wherein the MPFI provides information that the model training function 112 can use to determine whether the AI model needs to be updated or replaced by a new AI model.
E2. The network node of embodiment E1, wherein the network node is further configured to perform the method of any one of embodiments A2-A5.
F1. A network node 102, the network node being configured to: receive first model performance feedback information, MPFI, for a first existing artificial intelligence, AI, model used by a first network node 101; and use the first MPFI to determine whether a new AI model (e.g., new AI model parameters) needs to be provided to the first network node so that the first network node can update or replace the first existing AI model with the new AI model.
F2. The network node of embodiment F1, wherein the network node is further configured to perform the method of any one of embodiments B2-B4.
G1. A network node 103, the network node being configured to: obtain inference input data; obtain uncertainty information indicating an uncertainty measure associated with the inference input data; and provide to a model inference function 111 the inference input data and the uncertainty information associated with the inference input data.
H1. A network node 101, 102, 103, the network node comprising: a data storage system 708; and processing circuitry 702, wherein the network node is configured to perform any one of the methods disclosed herein.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a first network node, the method comprising:
the first network node obtaining model performance feedback information, (MPFI) for an artificial intelligence (AI) model; and
the first network node providing the MPFI to a model training function, wherein
the MPFI provides information that the model training function can use to determine whether the AI model needs to be updated or replaced by a new AI model.

2. The method of claim 1, wherein the MPFI comprises of:
a) information related to uncertainty associated to one or more model inference data samples,
b) information related to uncertainty associated to one or more AI model inference output,
c) information that can indicate the uncertainty of the predictions made by the AI model, and/or
d) information associated to the predictions made by the AI model.

3. The method of claim 1, further comprising determining whether a condition is satisfied, wherein
the first network node provides the MPFI to the model training function in response to determining that the condition is satisfied, and
determining whether the condition is satisfied comprises:
the first network node determining an uncertainty value indicating an uncertainty with respect to an input to the AI model or indicating an uncertainty with respect to an output of the AI model; and
comparing the uncertainty value to a threshold.

4. The method of claim 1, wherein the first network node periodically obtains MPFI and periodically provides the MPFI to the model training function.

5. The method of claim 1, wherein providing the MPFI to a model training function comprises the first network node transmitting the MPFI to a third network node that is configured to forward the MPFI to the model training function.

6. A method performed by a second network node, the method comprising:
the second network node receiving first model performance feedback information; (MPFI) for a first existing artificial intelligence (AI) model used by a first network node; and
the second network node using the first MPFI to determine whether a new AI model needs to be provided to the first network node so that the first network node can update or replace the first existing AI model with the new AI model.

7. The method of claim 6, wherein the MPFI comprises:
a) information related to uncertainty associated to one or more model inference data samples,
b) information related to uncertainty associated to one or more AI model inference output,
c) information that can indicate the uncertainty of the predictions made by the AI model, and/or
d) information associated to the predictions made by the AI model.

8. The method of claim 6, further comprising:
in response to determining that a new AI model needs to be provided to the first network node, obtaining the new AI model; and
providing the new AI model to a first network node.

9. The method of claim 6, further comprising:
the second network node receiving second MPFI for a second existing AI model used by a fourth network node; and
the second network node using the first MPFI and the second MPFI to determine whether a new AI model needs to be provided to at least one of the first network node and the fourth network node.

10. A method comprising:
a network node obtaining inference input data;
the network node obtaining uncertainty information indicating an uncertainty measure associated with the inference input data; and
the network node providing to a model inference function the inference input data and the uncertainty information associated with the inference input data.

11. A non-transitory computer readable storage medium storing a computer program comprising instructions which when executed by processing circuitry of a network node causes the network node to perform the method of claim 1.

12. A non-transitory computer readable storage medium storing a computer program comprising instructions which when executed by processing circuitry of a network node causes the network node to perform the method of claim 6.

13. A network node, the network node comprising:
processing circuitry; and
a non-transitory computer readable storage medium storing a computer program comprising instructions which when executed by the processing circuitry causes the network node to perform the method of claim 1.

14. The network node of claim 13, wherein the MPFI comprises:
a) information related to uncertainty associated to one or more model inference data samples,
b) information related to uncertainty associated to one or more AI model inference output,
c) information that can indicate the uncertainty of the predictions made by the AI model, and/or
d) information associated to the predictions made by the AI model.

15. A network node, the network node comprising:
processing circuitry; and
a non-transitory computer readable storage medium storing a computer program comprising instructions which when executed by the processing circuitry causes the network node to perform the method of claim 6.

16. The network node of claim 15, wherein the MPFI comprises:
a) information related to uncertainty associated to one or more model inference data samples,
b) information related to uncertainty associated to one or more AI model inference output,
c) information that can indicate the uncertainty of the predictions made by the AI model, and/or
d) information associated to the predictions made by the AI model.

17. A network node, the network node comprising:
processing circuitry; and
a non-transitory computer readable storage medium storing a computer program comprising instructions which when executed by the processing circuitry causes the network node to perform the method of claim 10.

18. A non-transitory computer readable storage medium storing a computer program comprising instructions which when executed by processing circuitry of a network node causes the network node to perform the method of claim 10.
